(19) United States
(12) Patent Application Publication
(10) Pub. No.: US 2015/0329318 A1
(43) Pub. Date: Nov. 19, 2015

(54) ACTUATING AN ELECTROMAGNETIC ELEVATOR BRAKE FOR AN ELEVATOR INSTALLATION

(71) Applicant: Invento AG, Hergiswil (CH)

(72) Inventors: Andrea Cambruzzi, Zürich (CH); Simon Solenthaler, Klingnau (CH)

(73) Assignee: Inventio AG, Hergiswil (CH)

(21) Appl. No.: 14/649,245

(22) PCT Filed: Nov. 29, 2013
(86) PCT No.: PCT/EP2013/075048

§ 371 Date: Jun. 3, 2015

(30) Foreign Application Priority Data
Dec. 3, 2012 (EP) 12195316.0

(51) Int. Cl. B66B 1/32

(52) U.S. Cl. CPC B66B 1/32

(57) ABSTRACT

A device for actuating an electromagnetic elevator brake in an elevator installation includes at least two outlets connected to a coil of the brake, and a control system. Also provided is a switchable dissipation device, which is connected to the two outlets. In a rapid actuation operating mode, the control unit switches the switchable dissipation device such that the magnetic energy stored in the coil dissipates rapidly. Rapid actuation of the elevator brake is thus made possible.

### FIELD

The invention relates to a method of activating an electromagnetic elevator brake, to a device for activating an electromagnetic elevator brake, to a brake device and to an elevator installation with a corresponding control. Brake devices of that kind are preferentially used when the elevator installation stops at a stopping point or when the elevator installation has to be rapidly braked in an emergency situation.

### BACKGROUND

A control device for an emergency situation of an elevator car is known from GB 2 153 465 A. In the known control device a braking force of an elevator brake device can be controlled in steps or continuously in dependence on the loading of the elevator car. This control device has the disadvantage that the elevator brake can respond only after a certain time. During this time the elevator car can, for example, be accelerated. The travel of the elevator car as well as the braking travel covered up to response of the elevator brake then increases.

Known solutions such as disclosed in, for example, EP 2 028 150 use over-voltage discharge means in order to break down induction voltages at the time of switching brake coils.

### SUMMARY

An object of the invention is to indicate a method of activating an electromagnetic elevator brake, a device for activating an electromagnetic elevator brake, brake equipment with such a device and an elevator installation with such brake equipment. An improved mode of functioning of the elevator brake, particularly a shorter response behavior or a more rapid response of the elevator brake, shall thus be made possible.

The object is fulfilled by a method or a device as described in the following. In that regard, an electromagnetic elevator brake can be opened and held open by means of a coil. For that purpose an actuating voltage is applied to the coil. On receipt of a rapid actuation signal—which can be issued, for example, at least indirectly by an elevator control, safety monitoring means or an emergency switch—a dissipation device is switched so that a magnetic energy stored in the coil rapidly dissipates or can be discharged. The dissipation device for that purpose comprises at least one switching unit, which is activated by a control such as a brake control or a module of the elevator control or a drive control. With the rapid dissipation of the magnetic energy stored in the coil a decay time until release of an armature plate of the electromagnetic elevator plate is shortened and the elevator brake can be rapidly applied. In order to achieve this, for preference when the dissipation device is switched a dissipation voltage directed oppositely to the actuating voltage is transiently connected with the coil. Alternatively, when the dissipation device is switched the coil can be substantially short-circuited. Through the short-circuiting, which is controlled by means of switching units, of the coil it is thus not necessary to wait until a high coil voltage induced by the coil has built up and any over-voltage discharge means respond, but the short-circuiting and thus the discharge of the energy present in the coil take place immediately and rapidly. In addition, a short-circuit can be maintained until the induced voltage has decayed completely or to a desired extent.

Accordingly, a device for activating the electromagnetic elevator brake comprises at least terminals connectible with a voltage supply and at least two outputs connectible with the coil of the electromagnetic elevator brake. The device can provide an actuating voltage required for releasing the elevator brake or keeping the elevator brake released. In addition, the device comprises at least one control with a switchable dissipation device. The dissipation device or the at least one switching unit of the dissipation device is switched, at least indirectly, between the supply voltage and the two outputs. The control is usually connectible with an elevator control and in a normal operating mode it can so switch the switchable dissipation device that the actuating voltage required for keeping the elevator brake disengaged is applied to the two outputs of the coil. When required, or on receipt of a corresponding signal from the elevator control, the control can switch the switchable dissipation device to a rapid actuation operating mode, a rapid dissipation or discharge of a magnetic energy stored in the coil being made possible in this rapid actuation operating mode.

Further advantageous embodiments and developments are described in the following.

The device and the electromagnetic elevator brake are primarily suitable for an elevator installation. A corresponding brake is obviously also conceivable in other conveying means such as, for example, an escalator. In that regard, the electromagnetic elevator brake is not necessarily a component of the device for activating the electromagnetic elevator brake. For example, the device can also be manufactured and marketed independently of the electromagnetic elevator brake. Correspondingly, the brake device also be manufactured and marketed independently of the other components of an elevator installation.

The elevator brake can, for example, be used when the elevator car of the elevator installation stops at a stopping point and the drive motor is switched off. In addition, such an elevator brake can also be used when incorrect behavior of the elevator car is ascertained. Such incorrect behavior can occur, for example, during loading of the elevator car if the elevator car suddenly moves off and quasi slips away. In such and similar situations a rapid reaction of the elevator brake is possible. In that case an appropriately rapid braking action is achieved. This means on the one hand that the travel of the elevator car until response of the elevator brake is reduced. On the other hand, this usually also means that the acceleration phase and thus the speed of the elevator car reached at response of the elevator brake are reduced, which shortens braking travel. However, even in the case of unintended, necessary braking of the elevator car during an elevator journey a rapid reaction for generation or adaptation of required braking forces can be achieved. The possible shortening of the reaction time of the elevator brake is thus accompanied by significant advantages in different situations.

It is advantageous that the switchable dissipation device in a rapid actuation switching setting for the rapid actuation operating mode generates a dissipation voltage which lies between the two outputs and is directed oppositely to the actuating voltage serving for energization of the coil. For that purpose, for example, a voltage source used for operation of the elevator brake is switched over by means of the switching units in such a way that the voltage is reversed in polarity relative to the supply voltage to the coil. In order to achieve rapid reaction of the electromagnetic elevator brake, for the purpose of actuation of the elevator brake a coil current is thus not only set to zero, but for a limited time is set to a negative voltage. Rapid dissipation or rapid discharge of the magnetic energy stored in the coil is thus made possible. The magnetic field of the coil thus breaks down more rapidly. The actuation of the elevator brake is thereby possible more rapidly. In particular, the elevator brake can be designed so that a braking action is achieved when the coil is de-energized. The braking force can in that case be applied by, for example, a brake spring. In this embodiment the magnetic field of an electromagnet can be broken down more rapidly, whereby the brake spring can exert the braking action more rapidly. More rapidly in this case means that by comparison with a coil in which merely the current feed is interrupted, the magnetic field is broken down in a shorter time.

The generation of the dissipation voltage can also be used in the case of a required adaptation of a braking force of the elevator brake, because in such cases a rapid adaptation of the magnetic force of the electromagnet is advantageous.

In that case it is additionally advantageous that the dissipation device in the rapid actuation switch setting generates the dissipation voltage, which is present between the two outputs, to be at least approximately the same in terms of amount as the actuating voltage serving for energization. In particular, the desired shortening of the reaction time can then be achieved, as it were, by selective temporary pole reversal. A time period of the pole reversal is effected transiently so as to prevent the coil from building up a magnetic field again.

Moreover it is advantageous that an output device having two oppositely directed Zener diodes, by which the actuating voltage and the dissipation voltage are determined at least approximately, is provided. The output device and dissipation device in that case are not necessarily arranged in immediate proximity, for example on a common circuitboard. In particular, the output device can also be arranged directly at the coil and the dissipation device accommodated separately. The form of the output device with the two oppositely directed Zener diodes additionally enables simple adaptation to different circumstances of use, especially different electromagnetic elevator brakes. Zener diodes in the form of suppressor diodes are typically used in this circuit. Suppressor diodes are also known by the term Transient Absorption Zener diodes (TAZ diode) and are suitable for switching the required switching leads.

Moreover, an embodiment is advantageous in which the dissipation device comprises a suppressor diode and a switching unit, wherein the suppressor diode in a rapid actuation switch setting for the rapid actuation operating mode is connectible at least indirectly between the two outputs. As a result, the energy of the coil can be rapidly dissipated. Through the rapid conducting away of the energy, which can take place even without a negative voltage, a more rapid reaction time is similarly achievable.

It is also advantageous that the control comprises a time presetting device which determines a rapid actuation time for the rapid actuation operating mode and that the control switches the dissipation device—only up to expiry of the rapid actuation time —so that the more rapid dissipation of the magnetic energy stored in the coil is made possible. The rapid actuation time can be, for example, up to approximately 40 milliseconds. A more advantageous value for the rapid actuation time is approximately 30 milliseconds. The actual determination of the rapid actuation time can in that regard be preset with reference to the respective case of use, in particular the elevator brake employed. In that regard, a capability of setting the rapid actuation time may also be advantageous in order to enable adaptation to the respective case of use.

Moreover, it is advantageous that the control comprises a brake setting detection device which detects at least one change in actuation of the elevator brake and that the control switches the dissipation device—until the brake setting detecting device detects that the actuation change takes place—so that the rapid dissipation of the magnetic energy stored in the coil is made possible. In that connection it is additionally advantageous that a sensor is provided which detects movement of an armature plate of the electromagnetic elevator brake and that the sensor is connected with the brake setting detection device of the control. For example, the sensor can detect when the armature plate with a brake lining detaches from the electromagnet, because this means that the magnetic energy of the coil has been substantially dissipated. Detection of the movement can then be realized by positional detection. However, design as a scanner, switch or simple conductor contact, which is opened and closed, is also possible. A signal of the brake setting detection device can also be transmitted to the elevator control, which can recognize therefrom a working setting of the elevator brake. Switching of the dissipation device obviously always means switching of at least one switching unit of the dissipation device.

Moreover, it is advantageous to provide a Hall sensor. The control switches the dissipation device—until the Hall sensor detects that the magnetic field of the coil has at least approximately disappeared—so that the more rapid dissipation of the magnetic energy stored in the coil is made possible. In this embodiment the magnetic field of the coil can be measured by means of the Hall sensor so as to detect whether the magnetic energy has been at least substantially dissipated.

Furthermore, it is advantageous if a coil current measuring device which detects a coil current of the coil is provided. In that case the control switches the dissipation device until the coil current measuring device detects that the coil current of the coil has at least approximately disappeared. Rapid dissipation of the magnetic energy stored in the coil is thus made possible. In this embodiment a conclusion about the magnetic field of the coil can be made from the coil current. An advantageous limitation of the switching-on of the dissipation device for the rapid actuation operating mode is then equally possible. The illustrated variants, such as presetting of the rapid actuation time, brake setting detection device, magnetic field measurement by means of Hall sensor or coil current measurement, can be used in different combinations individually or together. It is thus ensured that the magnetic field is not built up again.

### DESCRIPTION OF THE DRAWINGS

Embodiments of the invention are explained in more detail in the following description by way of the accompanying schematic drawings, in which corresponding elements are provided with corresponding reference numerals and in which:

FIG. 1 shows a brake device with a device for activating an electromagnetic elevator brake in a schematic illustration in the form of a detail for explanation of the mode of functioning of corresponding possible embodiments of the invention;

FIG. 2 shows a device for activating an electromagnetic elevator brake of the brake device, which is illustrated in FIG. 1, in correspondence with a first embodiment of the invention in a schematic illustration in the form of a detail;

FIG. 3 shows a device for activating an electromagnetic elevator brake of the brake device, which is illustrated in FIG. 1, in correspondence with a second embodiment in a schematic illustration in the form of a detail; and

FIG. 4 shows an elevator installation with a brake device and associated device for activating the brake device.

### DETAILED DESCRIPTION

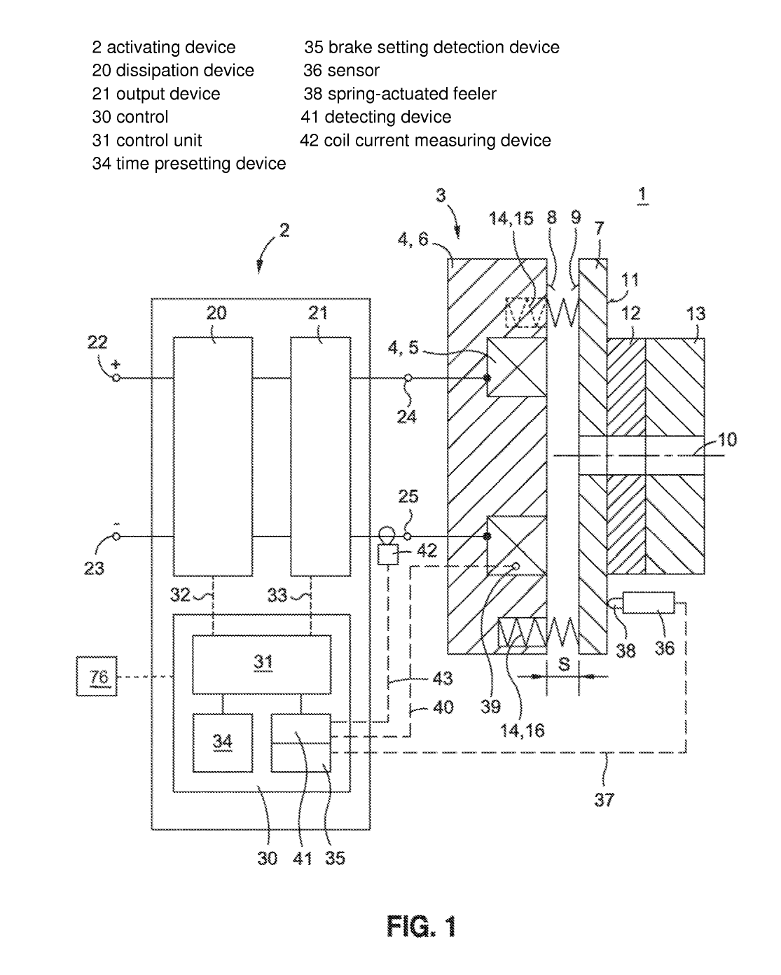

The brake device 1 according to the embodiment of FIG. 1 comprises an electromagnetic elevator brake 3 and a device 2 for activating the electromagnetic elevator brake 3. The electromagnetic elevator brake 3 is in that regard not necessarily a component of the device 2. In particular, the device 2 can also be produced and marketed independently of the electromagnetic elevator brake 3. Moreover, an embodiment of the device 2 which enables adaptation of the device 2 to electromagnetic elevator brakes 3 of different design is possible,

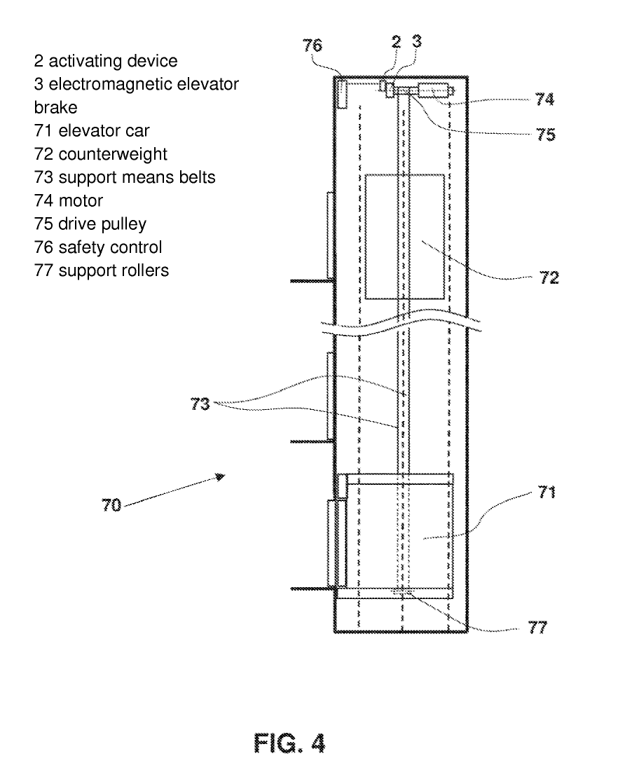

The brake device 1 serves, as schematically illustrated in FIG. 4, by way of example for an elevator installation 70. The elevator installation 70 includes an elevator car 71 which is connected with a counterweight 72 via support means 73, for example support belts. The support means 73 is for that purpose suspended by way of, for example, support rollers 77. The or each support means 73 is driven by a drive pulley 75, whereby the elevator car 71 and the counterweight 72 move on travel paths of opposite direction. A motor 74 can drive the drive pulley 75 when required and the elevator brake 3 can when required brake the drive pulley 75 or keep it at standstill. Holding or braking of the elevator car 71 then results by way of the support means 73 of the elevator car 71. However, a use is also conceivable in which the elevator car 71 is directly braked (not illustrated), for example in relation to a rail mounted in stationary position in the elevator shaft and serving for the braking. The elevator brake 3 is activated by way of the device 2 from an elevator or safety control 76.

The elevator brake 3 comprises, as apparent in FIG. 1, an electromagnet 4 with a coil 5 and a ferromagnetic core 6, in particular an iron core 6. Moreover, the elevator brake 3 comprises an armature plate 7. The electromagnet 4 has an end face 8 facing an end face 9 of the armature plate 7. A spacing s is defined between the end face 8 of the electromagnet 4 and the end face 9 of the armature plate 7. For explanation of the mode of functioning, the electromagnet 4 is regarded as stationary. This stationary arrangement can be realized, for example, in relation to a housing (not illustrated) of the elevator brake 3. Thereagainst, the armature plate 7 is arranged to be movable along an axis 10. The spacing s given between the end face 8 of the electromagnet 4 and the end face 9 of the armature plate 7 is thus dependent on the position of the armature plate 7. The spacing s can in that case even disappear if the armature plate 7 bears by the end face 9 thereof against the end face 8 of the electromagnet 4. However, depending on the respective embodiment a minimum spacing can in that regard be constructionally predetermined in order to facilitate release of the armature plate 7 from the electromagnet 4. A brake lining 12 is mounted at a side 11 of the armature plate 7 remote from the end face 9. Moreover, a counter-member 13, which can be designed as, for example, a brake disc 13, is provided. In this embodiment the brake lining 12 bears against the counter-member 13 so that a braking action is achieved. If the spacing s starting from the brake setting illustrated in FIG. 1 is reduced then the brake lining 12 detaches from the counter-member 13 so that the elevator brake 3 is released. This release of the elevator brake is achieved in this embodiment by energization of the coil 5 of the electromagnet 4. In that case the armature plate 7 moves by its end face 9 to the end face 8 of the electromagnet 4.

The elevator brake 3 additionally comprises a mechanical elevator brake device 14 which in this embodiment comprises spring elements 15, 16. The spring elements 15, 16 are in that case arranged at the side 9 of the armature plate 7 between the electromagnet 4 and the armature plate 7. The spring elements 15, 16 are biased and press against the surface 9. The spring elements 15, 16 are preferably compression springs and are arranged, for example, to be recessed in the electromagnet. Several of these spring elements 15, 16 are, by way of example, arranged in distribution around a circumference of the electromagnet or the armature plate. A mechanical force Fₖ exerted by the mechanical elevator brake device 14 on the armature plate 7 is in this example described by a spring force Fₖ with the spring constant k. If the spacing s disappears, then in this example a maximum spring force F₀ is applied by the mechanical elevator brake device 14.

In the formulation of an equation for description of the electrical behavior of a circuit with the coil 5 the coil can, depending on how presented, be regarded as current source or consumer. If the coil is regarded as consumer, then the voltage decay present at the coil 5 arises as a product of the inductance L of the coil 8 and the time derivative of the instantaneously flowing current I. If, in addition, a resistive impedance R is taken into consideration, which apart from the resistive impedance of the coil 5 arises from the characteristics of the device 2, the electrical behavior can be described by

$$U = I \cdot R + L ( s ) \cdot \frac{d I}{d t} \qquad Equation ( 1 )$$

The electromotive force U present is then split between the resistance R and the coil 5 considered as consumer. In that case it is to be considered that the inductance L of the coil 5 depends on the spacing s. The inductance L is thus a function of the spacing s, i.e. L=L(s). The response behavior of the elevator brake 3 in terms of time can be described by

$$I = \frac{U}{R} ( 1 - {e}^{- \frac{t}{τ}} ) \qquad Equation ( 2 )$$

In that case, τ_{L} arises as a solution of the differential equation described by Equation (1). If, for example, the current I=0 at the time instant t=0, then the rise in the current I over time results according to

$$I = \frac{U}{R} ( 1 - {e}^{- \frac{t}{τ}} ) \qquad Equation ( 3 )$$

After the time t=τ, the difference of the current I from the end value U/R, towards which the current I converges from below, is still 1/e. Here, e is the Euler number.

The magnetic flux Φ results approximately from the magnetic resistance Rₘ for the ferromagnetic core 6 and the armature plate 7, the magnetic resistance Rₛ for the air gap with consideration of the spacing s, the winding number N and the current I according to

$$Φ = \frac{N \cdot I}{{R}_{s} \cdot s + {R}_{m}} \qquad Equation ( 4 )$$

In the case of quasi static consideration, only the current flow I depends on time, so that in relation to the self-induction concerning all N windings of the coil the self-inductance L(s) arises in accordance with

$$L ( s ) = \frac{{N}^{2}}{{R}_{s} \cdot s + {R}_{m}} \qquad Equation ( 5 )$$

Thus, for the derivative of the self-inductance L(s) in accordance with the spacing s there applies the approximation made in

$$\frac{d L ( s )}{d s} = \frac{- {N}^{2} \cdot {R}_{s}}{{( {R}_{s} \cdot s + {R}_{m} )}^{2}} \qquad Equation ( 6 )$$

However, for example, depending on the respective case of use a series expansion can also be employed.

The resulting braking force F_{B} by which the armature plate 7 is loaded along the axis 10 is relevant for operation of the elevator brake 3. The braking force F_{B} is the pressing force by which the brake lining 12 is pressed against the counter-member 13. In that case, the force F_{B} results from the mechanical spring force Fₖ and the electromagnetic force Fₘ given by the electromagnet 4. The force F_{B} thus results from the sum of the mechanical spring force Fₖ and the magnetic force Fₘ as indicated in

$${F}_{B} = {F}_{k} + {F}_{m} \\ {F}_{B} = ( {F}_{0} - k \cdot s ) + ( \frac{1}{2} {I}^{2} \frac{d L ( s )}{d s} ) \qquad Equation ( 7 )$$

If the spacing s disappears then the mechanical spring force Fₖ adopts its maximum value F₀. For a given spacing s the braking force F_{B} is thus a quadratic function of the current I through the coil 5. The braking force F_{B} desired in operation can thus be set by way of the current I. If the armature plate 7 is in the setting illustrated in FIG. 1, in which the brake lining 12 bears against the counter-member 13, then resulting from the braking force F_{B} is, in particular, retardation of the rotating drive pulley 75, the travelling elevator car 71 and the like.

If the spacing s disappears and the elevator brake 3 is thus disengaged then for that purpose energization of the coil 5 is necessary. The supply of current to the coil 5 then has to be of such a magnitude that the restoring force Fₒ of the spring elements 15, 16 is overcome. A specific magnetic flux Φ is in that case generated by the current I and described by Equation (4). A magnetic (electromagnetic) energy stored in the coil 5 corresponds therewith. If from this position the elevator brake 3 is to be engaged, then the self-induction inhibits the required adaptation of the current I, in particular reduction of the current I to an at least substantially imperceptible value. This results from the Equation (1), wherein the value τ_{L} indicated in Equation (2) is a measure for the time period of the adaptation. A specific response delay of the elevator brake 3 thus occurs.

A corresponding delay in the adaptation can have a significant role even when the elevator brake 3 is applied. For example, a comparatively small braking action can be achieved by presetting a specific current I through the coil 5. In this initial situation it is conceivable that rapid increase in braking action is required. For that purpose, a rapid reduction in the current I is similarly required, particularly reduction of the current I to an imperceptible value.

For the stated reasons, a shortening of the reaction time in the sense of a more rapid adaptation of the coil current I in specific operating states is of significant advantage, because as a result there can be, in particular, rapid reaction to faulty functions. The device 2 according to the invention for activating the electromagnetic elevator brake 3 enables such a rapid reduction of the current I flowing through the coil 5.

The device 2 for activating the electromagnetic elevator brake 3 comprises a dissipation device 20 and an output device 21. In addition, terminals 22, 23 between which a supply voltage is present are provided. In that regard, the terminal 22 is connected with a positive pole, whilst the terminal 23 is connected with a negative pole, of the supply voltage. The device 2 additionally comprises outputs 24, 25. In this embodiment the outputs 24, 25 are connected with the dissipation device 20 by way of the output device 21.

In the mounted state, the coil 5 is electrically connected with the outputs 24, 25 of the device 2. An actuating voltage, which is delivered by way of the output device 21 and which is present between the outputs 24, 25, then serves for generating the current I through the coil 5, as is described by the Equation (3).

The device 2 additionally comprises a control 30. The control 30 comprises a control unit 31, which is connected with the dissipation device 20 and the output device 21 by way of control lines 32, 33. In addition, the control 30 comprises a time presetting device 34. The control 30 is connected with an elevator or safety control 76 which generates the required engaging or disengaging commands for the control 30.

In one possible mode of operation the control unit 31 reverts to a rapid actuation time determined by the time presetting device 34. In operation, for example, a faulty function can be recognized while the elevator brake 3 is disengaged and the spacing s disappears. In that case, the coil is supplied with a sufficiently large current I. Due to the known or possible faulty function the elevator control 76 ascertains that, for example, a rapid actuation operating mode has to be performed in order to achieve rapid actuation of the elevator brake 3 and it transmits a corresponding signal to the control 30 and additionally to the control unit 31. The dissipation device 20 is designed as a switchable dissipation device 20. In that case, the dissipation device 20 is switchable from at least one other mode of operation to the rapid actuation operating mode. In the rapid actuation operating mode the control unit 31 now switches the dissipation device 20 so that a rapid dissipation of the magnetic energy stored in the coil 5 takes place. Through this rapid dissipation of the magnetic energy stored in the coil 5 of the electromagnet 4 the current I through the coil 5 correspondingly also rapidly decays so that the response delay of the elevator brake 3 is substantially shortened.

In accordance with the rapid actuation time predetermined by the time presetting device 34 the control unit 31 switches the dissipation device 20 from the rapid actuation operating mode to another mode of operation. The rapid actuation time predetermined by the time presetting device 34 can, in particular, lie in a range of up to approximately 40 milliseconds. For preference, a rapid actuation time can be approximately 30 milliseconds. In the case of acceleration of the regulating process during elevator braking, however, preferably other rapid actuation times are predetermined, because when the elevator brake 3 is engaged the armature plate 7 is already detached from the electromagnet 4 so that the coil 5 operates in a different working range. In that regard, the dependence on the spacing s also plays a part, as expressed in Equations (1) to (7). In such cases, detection of the coil current I or detection of the setting of the armature plate 7 can also come into use, as also further described in the following.

In a further possible embodiment the control 30 comprises a brake setting detection device 35. In addition, a sensor 36 connected by way of a signal line 37 with the brake setting detection device 35 is provided. In this embodiment the sensor 36 comprises a spring-actuated feeler 38, by way of which the position of the armature plate 7 is detected. In particular, it can be detected whether the armature plate 7 bears by the end face 9 thereof against the end face 8 of the electromagnet 4 or whether the elevator brake 3 is applied, as illustrated in FIG. 1.

A change in actuation of the elevator brake 3 is detected by the brake setting detection device 35. In that case, not only disengagement, but also engagement of the elevator brake 3 can be detected. In a given case it can also be detected by a sensor 36 merely whether or not the armature plate 7 is disposed at the electromagnet 4.

In this embodiment, the control unit 31 of the control 30 switches the dissipation device 20—only until the brake setting detecting device 35 detects that the change in actuation takes place—so that rapid dissipation of the magnetic energy stored in the coil 5 takes place.

In a further possible embodiment a sensor 39 which measures the magnetic field, particularly the magnetic flux Φ, of the coil 5 is provided. The sensor 39 can be designed as, in particular, a Hall sensor 39. The Hall sensor 39 is connected by way of a signal line 40 with a detecting device 41 of the control 30. The detecting device 41 can detect by way of the Hall sensor 39 when the magnetic field of the coil 5 at least approximately disappears. The control 30 can thereby activate the dissipation device 20 only until the Hall sensor 39 detects that the magnetic field of the coil 5 has at least approximately disappeared.

In a further possible embodiment a coil current measuring device 42, which with respect to the outlet 25 is mounted on the side of the device 2, is provided. The coil current measuring device 42 can thereby be integrated in the device 2. The coil current measuring device 42 can, however, also be arranged on the side of the electromagnet 3. The coil current measuring device 42 detects the coil current of the coil 5. If the detecting device 41 connected with the coil current measuring device 42 by way of a signal line 43 detects that coil current I has at least approximately disappeared then the control unit 31 can terminate the rapid actuation operating mode and switch the dissipation device 20 back into another mode of operation.

Suitable threshold values are predetermined for the coil current I measured by the current measuring device 42 or the magnetic field measured by the sensor 39. In that regard, preferably low threshold values close to zero, which enable a decision as to whether or not the coil current I or the magnetic field of the coil 5 has at least substantially disappeared, are predetermined.

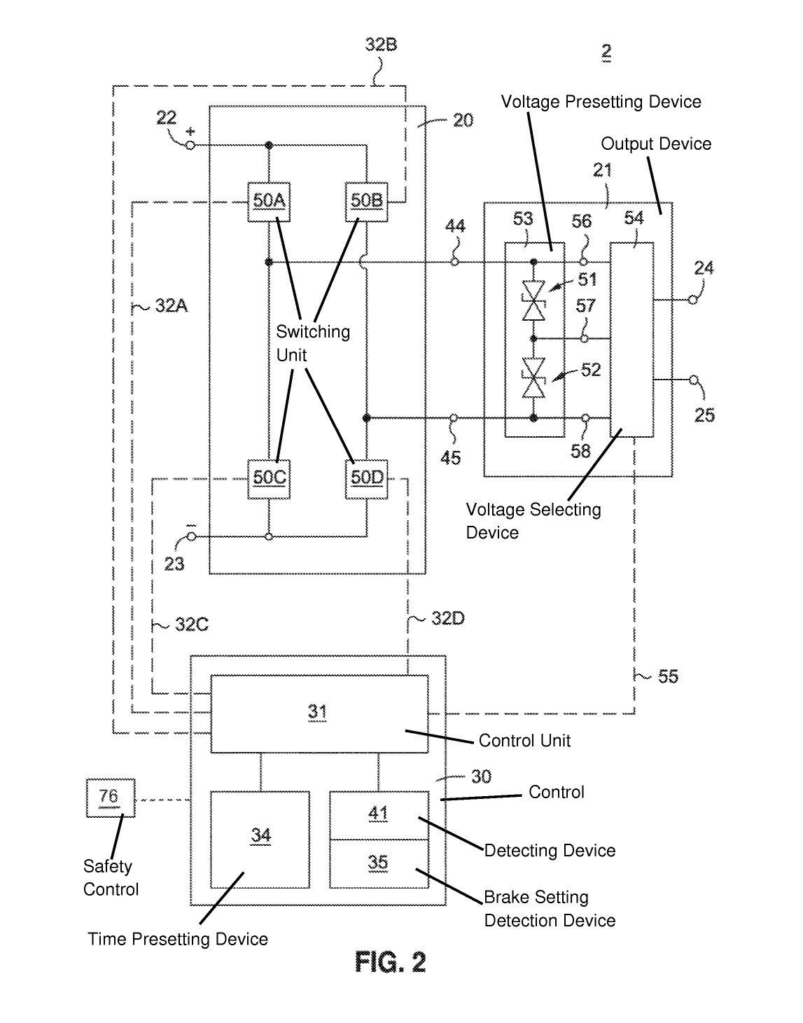

FIG. 2 shows the device 2 for activating the electromagnetic elevator brake 3 of the brake device 1, which is illustrated in FIG. 1, in correspondence with a first embodiment in a schematic illustration in the form of a detail. The common control line 32 shown in FIG. 1 comprises, in this embodiment, the control lines 32A to 32D. In addition, the dissipation device 20 and the output device 21 are connected together at points 44, 45, which represent on the one hand the outputs of the dissipation device 20 and on the other hand the inputs of the output device 21. For simplification of the illustration, devices such as the coil measuring device 42, the sensor 39 and the sensor 36 as well as the signal lines 37, 40, 43 relating thereto are not illustrated.

The dissipation device 20 comprises switching units 50A to 50D, which are connected with the control unit 31 by way of the signal lines 32A to 32D. The switching units 50A to 50D can, for example, each comprise one or more transistors. In that case, the switching units 50A to 50D in one switch setting can be switched to a quasi vanishing resistance and in another switch setting switched to a quasi infinitely high resistance. Also conceivable is an embodiment in which the switching units 50A to 50D can each be switched in one switching state to a low resistance and in another switching state to a high resistance. Further appropriate adaptations to the respective case of use are then possible. In the following for each of the switching units 50A to 50D one switching state is termed closed and another switching state is termed open.

The switching units 50A, 50B are on the one hand connected with the terminal 22 and thus with the positive pole of the supply voltage. On the other hand, the switching unit 50A is connected with the point 44, whilst the switching unit 50B is connected with the point 45. The switching units 50C, 50D are on the one hand connected with the terminal 23 and thus with the negative pole of the voltage supply. On the other hand, the switching unit 50C is connected with the point 44, whilst the switching unit 50D is connected with the point 45.

In one operating mode, which serves for energizing the coil 5, particularly for disengaging the elevator brake 3, the switching units 50A, 50D are closed whilst the switching units 50B, 50C are opened. As a result, on the one hand the terminal 22 is connected with the point 44. On the other hand, the terminal 23 is connected with the point 45.

The output device 21 comprises a first pair 51 of oppositely directed or bipolar suppressor diodes and a second pair 52 of bipolarly directed suppressor diodes. Resulting from the voltage now present between the points 44, 45 is thus an actuating voltage which lies between the outputs 24, 25 and which is determined by the suppressor diodes of the pairs 51, 52. In that case, the pairs 51, 52 are components of a voltage presetting device 53 of the output device 21. Moreover, the output device 21 additionally comprises a voltage selecting device 54 activatable by the control unit 31 by way of a control line 55. In this example, in particular, points 56, 57, 58 are provided, wherein an intermediate voltage can be tapped at the point 57. Through appropriate dimensioning of the suppressor diodes of the pairs 51, 52 the voltage selecting device 54 can thus select between two or three different voltages, which are output at the outputs 24, 25 as actuating voltage.

In the rapid actuation operating mode the control 30 sets the dissipation device 20 into a rapid actuation switch setting. In the rapid actuation switch setting the switching units 50A, 50D are opened and the switching units 50B, 50C closed. The terminal 22 is thus connected with the point 45, whilst the terminal 23 is connected with the point 44. With respect to the dimensioning of the pairs 50, 52 of suppressor diodes specific voltage potentials now arise at the points 56, 57, 58. Accordingly, a dissipation voltage directed oppositely to the previously effective actuating voltage is present between the outputs 24, 25. In a given case, the voltage selecting device 54 can then select between two or three voltage values for the dissipation voltage.

Due to the—so to speak—negative dissipation voltage applied to the coil 5 the energy stored in the coil 5 can be rapidly dissipated. A shortened response behavior thus results. The reduction in the coil current I takes place particularly on a shorter time scale than in the case of pure reduction of the voltage U to 0 volts.

The dissipation voltage thus serves as a counter-voltage.

The switching of the dissipation device 20 from the rapid actuation switch setting to the usual switch setting for energization of the coil 5 can be determined by, for example, the time presetting device 34 and/or the detecting device 41 and/or the brake setting detection device 36, as also described on the basis of FIG. 1.

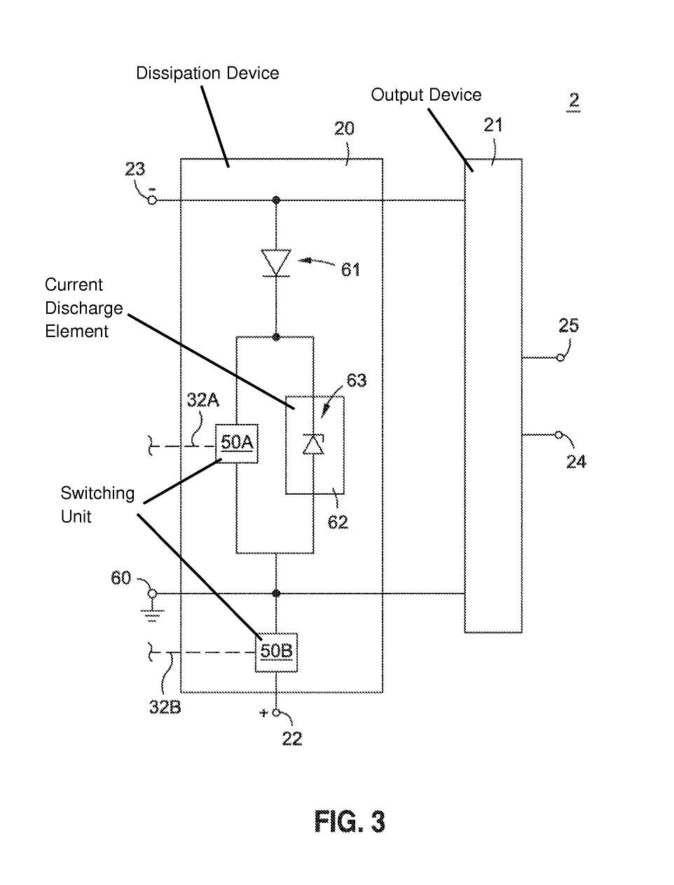

FIG. 3 shows the device 2 for activating the electromagnetic elevator brake 3 of the brake device 1, which is illustrated in FIG. 1, in correspondence with a second embodiment in a schematic illustration in the form of a detail. In this embodiment, switching units 50A, 50B, which are connected by way of signal lines 32A, 32B with the control unit 31, are illustrated. The dissipation device 20 is connected with the positive pole and the negative pole of the voltage supply by way of the terminals 22, 23. In addition, a terminal 60 connected with a floating ground is provided. If the switching unit 50B is closed, then the voltage potential at the terminal 60 is connected with the positive pole of the supply voltage at the terminal 22. In addition, a device can be provided which sets the potential at the terminal 60 with respect to the negative potential at the terminal 23.

The output device 21 can, for example, connect the terminal 23 with the output 25 and the terminal 60 with the output 24. For energization of the coil 5 the switching unit 50B is closed so that the actuating voltage lies between the outputs 24, 25. The elevator brake 3 is thereby disengaged. In the disengaged state of the elevator brake 3 a magnetic energy is stored in the coil 5.

In the rapid actuation operating mode the dissipation device 20 is switched to a rapid actuation switch setting. For that purpose the switching unit 50B is opened. In addition the switching unit 50A is closed. The switching unit 50A can in that case be switched to a vanishing resistance or also to a predetermined resistance. Moreover, it is possible for the switching unit 50A to be switched from a higher resistance to a lower resistance, particularly a vanishing resistance.

Thus, in the rapid actuation switch setting the induction voltage, or at least a part of the induction voltage, of the coil 5 now lies between the outputs 24, 25. The output 25 thereby lies at a higher voltage level by comparison with the output 24. A specific voltage drop thereby arises at a diode 61, which now lies in pass direction. A further voltage drop arises at a current discharge element 62 of the dissipation device 20. In this embodiment the current discharge element 62 comprises a suppressor diode 63. The suppressor diode 63 can be formed as, in particular, a TVS diode 63. By virtue of the voltage drop at the suppressor diode 63 a rapid dissipation of the magnetic energy stored in the coil 5 takes place.

In a simpler embodiment a higher resistance can also be used instead of the suppressor diode 63. Consequently, by means of the switching unit 50A there can be switching simply from a higher resistance to a lower resistance, particularly to a vanishing resistance.

The control 30 then switches the switchable dissipation device 20 back to a usual operating mode, which is made possible by, for example, the time presetting device 34 and/or the brake setting detection device 35 and/or the detecting device 41.

It is to be noted that primarily the mode of functioning of the switchable dissipation device in the rapid actuation operating mode is described on the basis of FIG. 3. Further functions such as regulation of the current I through the coil 5 in the normal operating mode can be realized by suitable devices. For that purpose, in particular, the potential of the terminal 60 can be varied in relation to the potential at the terminal 23. This is possible by, for example, a suitable circuit which is connected with the switching unit 50B. In that regard, a signal generator can be used which, for example, enables pulse width modulation.

It is to be noted that the dissipation device 20 is preferably switched into the rapid actuation switch setting only as long as the coil current I through the coil 5 at least approximately disappears, but does not build up in the opposite direction. It can thus be achieved that after the end of the rapid actuation operating mode the magnetic field has at least approximately disappeared or at least sufficiently diminished.

In the method for activating the electromagnetic elevator brake 3 the coil 5 of the elevator brake 3 is energized. In that case, switching to the rapid actuation operating mode is made possible. In the rapid actuation operating mode the energy stored by the current flow in the coil 5 rapidly dissipates.

In that regard, the method can be supplemented by suitable steps which can be used individually or in a suitable combination.

In the rapid actuation operating mode a dissipation voltage which is present between the two outputs and which is directed oppositely to the actuating voltage and serves for energization of the coil can be generated. In addition, in the rapid actuation operating mode the dissipation voltage present between the two outputs can in terms of amount then be generated to be at least approximately the same as the actuating voltage serving for the energization.

Moreover, it is possible for a rapid actuating time for the rapid actuation operating mode to be determined and the switching to the rapid actuation operating mode to be limited by the rapid actuation time.

In a modified embodiment of the method the magnetic energy of the coil 5 can be rapidly dissipated in the rapid actuation operating mode in that the current discharge element 62, in particular the suppressor diode 63, is connected between the outputs 24, 25.

In order to determine when the rapid actuation operating mode is terminated a change in actuation of the elevator brake can also be detected. Specifically, in that regard a movement of the armature plate 7 can be detected. Moreover, the magnetic field of the coil 5 can also be detected, wherein the rapid actuation operating mode is ended when the magnetic field of the coil 5 at least approximately disappears. Correspondingly, the actuation operating mode can be ended when it is detected that a coil current I of the coil 5 at least approximately disappears.

The invention is not restricted the described embodiments.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A method of activating an electromagnetic elevator brake, which elevator brake can be released and kept released by a coil, comprising the steps of:
applying an actuating voltage to the coil for keeping the elevator brake released;
receiving a rapid actuation signal delivered by a control; and
switching a dissipation device in response to the rapid actuation signal whereby a magnetic energy stored in the coil rapidly dissipates or is discharged and the elevator brake is rapidly applied, wherein
on switching of the dissipation device the rapid actuation signal transiently switches at least one switching unit whereby a dissipation voltage directed oppositely to the actuating voltage is connected with the coil, or
on switching of the dissipation device the rapid actuation signal switches at least one switching unit so that the coil is substantially short-circuited.

15. The method according to claim 14 wherein the switching of the dissipation device by the control is ended upon the occurrence of at least one:
a predetermined rapid actuation time is reached;
a change in actuation of the elevator brake is ascertained;
a magnetic field of the coil at least approximately disappears or a predetermined value is reached; and
a coil current through the coil at least approximately disappears or reaches a predetermined value.

16. An activating device for activating an electromagnetic elevator brake, the activating device comprising:
two terminals connectible with a supply voltage;
two outputs connectible with a coil of the electromagnetic elevator brake;
a control connectible with an elevator or safety control, wherein when the two terminals are connected to the supply voltage and the two outputs are connected to the coil the activating device provides an actuating voltage to keep the elevator brake released;
a switchable dissipation device with at least one switching unit connected at least indirectly between the two terminals and the two outputs, wherein the control in a normal operating mode switches the at least one switching unit to apply the actuating voltage between the two outputs, and wherein the control in a rapid actuation operating mode switches the at least one switching unit for rapid dissipation of a magnetic energy stored in the coil, the control in the rapid actuation operating mode transiently switches the at least one switching unit to connect a dissipation voltage directed oppositely to the activating voltage with the coil, or switches the at least one switching unit to substantially short-circuit the coil.

17. The activating device according to claim 16 wherein the dissipation voltage connected by the switchable dissipation device in the rapid actuation operating mode is approximately a same amount as the actuating voltage.

18. The activating device according to claim 16 wherein the switchable dissipation device includes a suppressor diode and the suppressor diode and the at least one switching unit are connected in the rapid actuation operating mode at least indirectly between the two outputs.

19. The activating device according to claim 16 wherein the control includes a time presetting device for the transient switching of the at least one switching unit to determine a rapid actuation time for the rapid actuation operating mode, and wherein the control switches the at least one switching unit only until expiration of the rapid actuation time to enable the rapid dissipation of the magnetic energy stored in the coil.

20. The activating device according to claim 16 wherein the control includes a brake setting detection device that detects at least one change in actuation of the elevator brake and in response switches the at least one switching unit of the dissipation device only until the brake setting detecting device detects that the at least one actuation change takes place to enable the rapid dissipation of the magnetic energy stored in the coil.

21. The activating device according to claim 20 including a sensor for detecting movement of an armature plate of the electromagnetic elevator brake and the sensor is connected with the brake setting detection device of the control.

22. The activating device according to claim 16 including a Hall sensor and wherein the control switches the at least one switching unit until the Hall sensor detects that the magnetic field of the coil at least approximately disappears or reaches a predetermined value to enable the rapid dissipation of the magnetic energy stored in the coil.

23. The activating device according to claim 16 including a coil current measuring device detecting a coil current of the coil and wherein the control switches the at least one switching unit until the coil current measuring device detects that the coil current through the coil at least approximately disappears or reaches a predetermined value to enable the rapid dissipation of the magnetic energy stored in the coil.

24. The activating device according to claim 16 including an output device having at least two oppositely directed suppressor diodes by which the actuating voltage and optionally the dissipation voltage are at least approximately limited.

25. A brake device with an electromagnetic elevator brake and the activating device according to claim 16 wherein the coil of the elevator brake is connected with the outputs of the activating device.

26. An elevator installation including the brake device according to claim 25.
